(19) United States
(12) Patent Application Publication
(10) Pub. No.: US 2022/0261570 A1
(43) Pub. Date: Aug. 18, 2022

(54) AUTHENTICATION OF USER INFORMATION HANDLING SYSTEM THROUGH STYLUS

(71) Applicant: Dell Products L.P., Round Rock, TX (US)

(72) Inventors: Gerald Rene Pelissier, Mendham, NJ (US); Hsu Feng Lee, Taipei (TW); Chin Leong Ong, Singapore (SG); Seng Choon Teh, Singapore (SG); Benedict Tiong Chee Tay, Singapore (SG); Yan Yan, Singapore (SG)

(73) Assignee: Dell Products L.P., Round Rock, TX (US)

(21) Appl. No.: 17/174,903

(22) Filed: Feb. 12, 2021

(51) Int. Cl. G06K 9/00; G06F 21/32; G06F 3/0354; G06F 1/3212; G06F 1/3209

(52) U.S. Cl. CPC G06K 9/00181; G06F 21/32; G06F 1/3209; G06F 1/3212; G06F 3/03545

(57) ABSTRACT

Security on an information handling system may be improved by using a stylus. A stylus provides unique information about a user that may not be acquired by an information handling system through other methods. For example, a user's handwriting is often unique to that user and may provide a security check on the information handling system to confirm the user's identity. Further, the stylus is usually held in the user's hand and may be used to check the user's fingerprint to confirm the user's identity. These authentication techniques, including fingerprinting and handwriting, may be used to maintain persistent authentication while the user is using the stylus. As the user continues to interact with the information handling system with the stylus, the stylus continues to receive the user's fingerprint and handwriting, which may be checked to confirm the user of the information handling system is still the expected user.

### FIELD OF THE DISCLOSURE

The instant disclosure relates to information handling systems. More specifically, portions of this disclosure relate to securely identifying users of the information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems have become embedded in users' lives based on their ability to store and process large amounts of different kinds of information. As a result, information handling systems may store confidential and private user information. Further, information handling systems are often connected to multiple services using users' credentials that are stored on the information handling systems. The presence of confidential information and user account information on the information handling system can create security concerns. If a malicious user is able to gain access to the information on the information handling system, the malicious user may be able to interrupt the user's life, steal the user's identity, gain access the user's confidential documents, or more. Conventional techniques for securing this information are cumbersome, require multiple steps for the user to execute, and usually require the user to remember one or more passcodes.

Shortcomings mentioned here are only representative and are included to highlight problems that the inventors have identified with respect to existing information handling systems and sought to improve upon. Aspects of the information handling systems described below may address some or all of the shortcomings as well as others known in the art. Aspects of the improved information handling systems described below may present other benefits than, and be used in other applications than, those described above.

### SUMMARY

A stylus may be used to provide security on an information handling system. A stylus provides unique information about a user that may not be acquired by an information handling system through other methods. For example, a user's handwriting is often unique to that user and may provide a security check on the information handling system to confirm the user's identity. Further, the stylus is usually held in the user's hand and may be used to check the user's fingerprint to confirm the user's identity. These authentication techniques, including fingerprinting and handwriting, may be used to maintain persistent authentication while the user is using the stylus. As the user continues to interact with the information handling system with the stylus, the stylus continues to receive the user's fingerprint and handwriting, which may be checked to confirm the user of the information handling system is still the expected user. For example, if the stylus is used by another user, the information handling system may recognize a different fingerprint and/or handwriting and change the authenticated user to a different use for the information handling system. As another example, a proximity of the stylus with the information handling system, such as measured by a wireless connection, may indicate when a user has walked away from the information handling system and indicate to the information handling system that the user should be logged out.

In some embodiments, a stylus may be used as a “key” to log into any of a group of shared information handling systems (IHSs). A shared IHS may refer to an IHS that offers access to multiple users, such as several users belonging to a corporate organization, several users belonging to a family, several users of the public, or the like. The stylus may be used to recognize and identify a current user of the stylus to determine whether the user is permitted access and/or what kind of access the user should be permitted. The stylus may be detected by multiple shared information handling system as the user approaches them, using wireless communications, and each respond by displaying a “welcome message.” A list of other nearby information handling systems may be displayed on the information handling systems for a certain time, after the stylus moves within close proximity of an information handling system. The selected information handling system may automatically pair with the stylus when the user uses the stylus to touch a screen with the stylus or touches a particular portion of the screen. A secured connection may then be established after both the stylus and the information handling system recognize that they belong to the same organization or have another predetermined characteristic in common. The stylus, which contains the credentials to connect to user's cloud notes account, may transfer the credentials to the information handling system, which may automatically connect the user to his or her account. The information handling system paired with the stylus may inform the other shared information handling systems that it is currently paired with the user's stylus and other information handling systems can stop displaying their “welcome” messages.

In some embodiments, the stylus may recognize and authenticate the user with fingerprint matching. When the stylus is in discoverable mode, shared information handling system may recognize that there is at least one stylus in proximity. Shared information handling system may display a welcome message on their screens, indicating that they are operational and available for use. As the user brings his or her stylus in closer proximity to a given information handling system screen, a one-on-one secured communication between the stylus and information handling system may be established. After establishment of the one-on-one secured communication, the tablet screen may display the user's name to indicate that the stylus has been recognized. After the user touches the screen, the stylus may transmit its passkey to the information handling system, and pairing may occur.

In some embodiments, an information handling system in use by a user may enter a low battery condition. When the information handling system enters a low battery condition, the information handling system may broadcast a query to its environment seeking other shared information handling system that are not currently in use. Once an unused information handling system has been identified, the information handling system currently in use may inform the user that another information handling system in close proximity has been identified as a possible successor device. The possible successor information handling system may flash a message on its screen to help the user to locate the device. The user may switch devices merely by moving his or her stylus to the new information handling system, with similar connection process as above taking place, and the former information handling system being logged out.

In one embodiment, a user may bring his or her stylus to a meeting room where there are shared information handling system. The user may easily pair his or her stylus with the information handling system and is able to use the stylus' fingerprint reader to login to his or her account. During the meeting, the user may take notes using the stylus and information handling system. After the meeting, the user may leave the room, and the tablet device he or she was using automatically logs out from his or her account. During log out, all content related to the user may be erased from the shared information handling system, being saved only to the user's cloud account. After the user returns home, the user may log on his or her information handling system using the stylus fingerprint reader. If the user wants to continue working on his or her notes, the user may touch the information handling system's screen with the stylus, select the notetaking application, and the latest notes are automatically loaded and presented on the information handling system.

In some embodiments, multiple types of authentication methods using a stylus may be combined to secure the information handling system. For example, a user of the information handling system may be authenticated based on security requirements configured in a security policy for the information handling system. Example authentication methods may include: handwritten password authentication, handwriting biometric recognition, fingerprint biometric recognition, and combinations thereof, including the combination of handwritten password and handwriting biometric recognition, the combination of handwritten password authentication and fingerprint biometric recognition, and the combination of handwritten password authentication, handwriting biometric recognition, and fingerprint biometric recognition.

Embodiments of the authentication methods disclosed herein may be performed on an information handling system with a wireless connection to a stylus. The stylus may include a short-range wireless communication module for communicating with the information handling system. The stylus may also include fingerprint sensing capability and/or the ability to perform Match On Chip (MOC) authentication, in which the stylus can match a user's fingerprint to a registered fingerprint to generate a fingerprint token that is transmitted to and verified by the information handling system to authenticate the user. The information handling system may include support for a secure operating system (OS) and/or a Trusted Execution Environment (TEE), an in-device digital ink recognition engine to perform handwriting-to-text translation, an in-device handwriting biometric recognition engine running in a secure OS to validate user handwriting biometric, a security service executing on the information handling system to manage a security level and perform persistent/periodic user validation by triggering fingerprint authentication on pen and receiving and passing on the authentication token to the secure OS for validation, and/or an authentication module (e.g., a gatekeeper) executing in the secure OS to validate user credentials according to a current security profile or level.

In one example, a user may be authenticated through a write-to-login method using optical character recognition (OCR), in which a user uses the information handling system and stylus for note taking. The user may obtain a convenient way to login to the information handling system by setting a password to 27h13a, and instead of entering the password via a keyboard or soft keyboard on a device, the user can scribbles 27h13a on the information handling system to unlock the device. The stylus stroke can remain on the display for only a fraction of time so that others not able to view the entire string of the password.

In another example, two-factor authentication combines OCR and handwriting biometric recognition allows a user to handle sensitive documents. The user may scribble a string of password on the device to login and use the information handling system to record important notes during confidential meetings. The system recognizes the user's handwriting biometrics, which serves as another layer of enhanced security to unlock the device. Even if another individual knows the user's password, the user's attempt to access the system will be denied because the system can recognize different handwriting biometrics.

In a further example, two-factor authentication combines OCR and fingerprint recognition may be specified in a security policy of the information handling system specifying two authentications for access to the system by a certain user or access to certain content on the system. While the user is using the system and writing the password to login, the stylus recognizes fingerprints and logs in the user using one, two, three, or more fingers for authentication. A malicious user's login attempt would fail even if the malicious user knows the password and mimics the user's handwriting because the fingerprint recognition detects an unmatched fingerprint on the stylus during login.

In another example, three-factor authentication combines OCR, handwriting biometric recognition, and fingerprint recognition in which the security policy of the information handling system specifies three authentications for access to the system by a certain user or access to certain content on the system. While the user is using the system and writing the password to login, the fingerprint recognition on the stylus recognizes fingerprints and logs in the user based on one, two, three, or more fingers and based on handwriting biometrics.

In a further example, persistent authentication may be performed alone or in combination with one of the one-factor, two-factor, or three-factor authentication techniques described above. The persistent authentication may include periodic sampling of a fingerprint in which after the user logs in to the system, the system continues to recognize handwriting and/or recognize fingerprints for authentication as the user writes. If the user leaves the system and stylus behind and another user picks up the paper and stylus and starts writing, the stylus may detect a different fingerprint and/or different handwriting biometrics and enforce a reauthentication process for access to the system and/or content.

According to one embodiment, a method may include receiving, by a first information handling system, user authentication information from a user of a stylus through the stylus, authenticating, by the first information handling system, the user of the stylus based on the user authentication information, retrieving, by the first information handling system, user information corresponding to the user of the stylus; and configuring the first information handling system by applying the user information. In some embodiments, the step of receiving the user authentication information may include receiving text corresponding to a handwritten password, receiving handwriting biometrics corresponding to a handwritten password, and/or receiving a fingerprint token. In some embodiments, the method may further include retrieving notes previously stored by the user of the stylus. In some embodiments, the step of retrieving the user information may include retrieving a user profile corresponding to the user of the stylus. In some embodiments, the step of configuring the first information handling system may include applying the user profile to the first information handling system. In some embodiments, the method may include determining, by the first information handling system, a predetermined period of time has passed without receiving input from the stylus, configuring the first information handling system to a default state after determining the predetermined period of time has passed, receiving, by a first information handling system, second user authentication information from a second user of a second stylus through the second stylus while in the default state, authenticating, by the first information handling system, the second user of the second stylus based on the second user authentication information, retrieving, by the first information handling system, second user information corresponding to the second user of the second stylus, and configuring the first information handling system by applying the second user information. In some embodiments, the method may further include determining, by the first information handling system, a battery charge level of the first information handling system is below a threshold level, transmitting, by the first information handling system, a low battery broadcast signal to a second information handling system, receiving, by the first information handling system, a notification from the second information handling system that the user was authenticated on the second information handling system, and configuring the first information handling system to a default state after receiving the notification from the second information handling system.

According to one embodiment, a method may include receiving, at a first information handling system, a low battery broadcast signal from a second information handling system while the first information handling system is in a sleep mode, transitioning, by the first information handling system, from the sleep mode into an awake mode in response to receiving the low battery broadcast signal, determining, by the first information handling system, whether a fingerprint token is received from a stylus that was previously authenticated to the second information handling system with a predetermined period of time of receiving the low battery broadcast signal, when the fingerprint token is received within the predetermined period of time, logging in a user associated with the fingerprint token to the first information handling system; and, when the fingerprint token is not received within the predetermined period of time, transitioning, by the first information handling system, from the awake mode to the sleep mode. In some embodiments, the method further includes broadcasting, by the first information handling system, a successful user login to other information handling systems. In some embodiments, the method further includes authenticating the user to cloud storage, wherein the step of authenticating a user to cloud storage includes receiving a handwritten password on a screen of the information handling system, converting the handwritten password into password text, and transmitting the password text to the cloud storage. In some embodiments, the step of authenticating the user to the cloud storage further includes determining handwriting biometrics based on the received handwritten password, and transmitting the handwriting biometrics to the cloud storage. In some embodiments, the method further includes logging out the user from the information handling system. and erasing data associated with the user from the information handling system. In some embodiments, the method further includes logging out the user from the information handling system after a predefined period of inactivity.

According to one embodiment, a method may include entering into wireless communication proximity with a first stylus, receiving a first fingerprint token associated with a first user from the first stylus, logging in the first user using the first fingerprint token, logging out the first user, entering into wireless communication proximity with a second stylus, receiving a second fingerprint token associated with a second user from the second stylus, logging in the second user using the second fingerprint token, and logging out the second user.

The method may be embedded in a computer-readable medium as computer program code comprising instructions that cause a processor to perform operations corresponding to the steps of the method. In some embodiments, the processor may be part of an information handling system including a first network adaptor configured to transmit data over a first network connection; and a processor coupled to the first network adaptor, and the memory.

As used herein, the term “coupled” means connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially parallel includes parallel), as understood by a person of ordinary skill in the art.

The phrase “and/or” means “and” or “or”. To illustrate, A, B, and/or C includes: A alone, B alone, C alone, a combination of A and B, a combination of A and C, a combination of B and C, or a combination of A, B, and C. In other words, “and/or” operates as an inclusive or.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus or system that “comprises,” “has,” or “includes” one or more elements possesses those one or more elements, but is not limited to possessing only those elements. Likewise, a method that “comprises,” “has,” or “includes,” one or more steps possesses those one or more steps, but is not limited to possessing only those one or more steps.

The foregoing has outlined rather broadly certain features and technical advantages of embodiments of the present invention in order that the detailed description that follows may be better understood. Additional features and advantages will be described hereinafter that form the subject of the claims of the invention. It should be appreciated by those having ordinary skill in the art that the conception and specific embodiment disclosed may be readily utilized as a basis for modifying or designing other structures for carrying out the same or similar purposes. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

For a more complete understanding of the disclosed system and methods, reference is now made to the following descriptions taken in conjunction with the accompanying drawings.

FIG. 1 is an illustration showing an example user authentication to an information handling system with a wireless stylus according to some embodiments of the disclosure.

FIG. 2 is a flow chart illustrating an example method for authenticating, locking, and logging out a user of an information handling system with a wireless stylus according to some embodiments of the disclosure.

FIG. 3 is a flow chart illustrating an example method for transferring a user to a second information handling system when a first information handling system enters a low battery condition.

FIG. 4 is a flow chart illustrating an example method for authenticating, locking, and logging out a user of an information handling system and a user cloud with a wireless stylus according to some embodiments of the disclosure.

FIG. 5 is a block diagram illustrating example operations executing on an information handling system for authenticating a user of the information handling system with a wireless stylus according to some embodiments of the disclosure.

FIG. 6 is a block diagram illustrating an example wireless stylus for authenticating a user with an information handling system according to some embodiments of the disclosure.

FIG. 7 is a flow chart illustrating an example method for authenticating a user with a wireless stylus and configuring an information handling system according to some embodiments of the disclosure.

FIG. 8 is a schematic block diagram of an example information handling system according to some embodiments of the disclosure.

FIG. 9 is a schematic block diagram of an example information handling system for mobile computing according to some embodiments of the disclosure.

### DETAILED DESCRIPTION

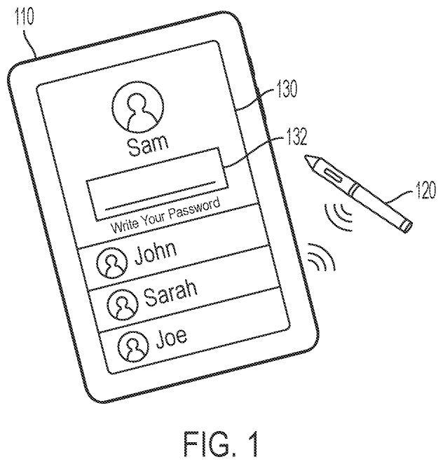

FIG. 1 is an illustration showing an example user authentication to an information handling system with a wireless stylus according to some embodiments of the disclosure. An information handling system 110 may include a display 130 for interacting with a user of the information handling system. The system 110 may communicate wirelessly with a stylus 120 to receive user input from the user, such as requests to access content, requests to access the system 110, handwriting input, fingerprint input, gestures, or other user input. When a user attempts to access the system 110 the user may be presented with a box 132 to write a password. The user may write their password with the stylus 120, instead of or in addition to typing a password on a physical or virtual keyboard of the system 110. The box 132 may be presented anytime a user attempts to access the system 110 or content through the system 110 that a security profile for the system 110 requires authentication. For example, a user may be provided some limited access to the system 110 initially, but when certain content or system features are requested, the user is prompted by box 132 to authenticate.

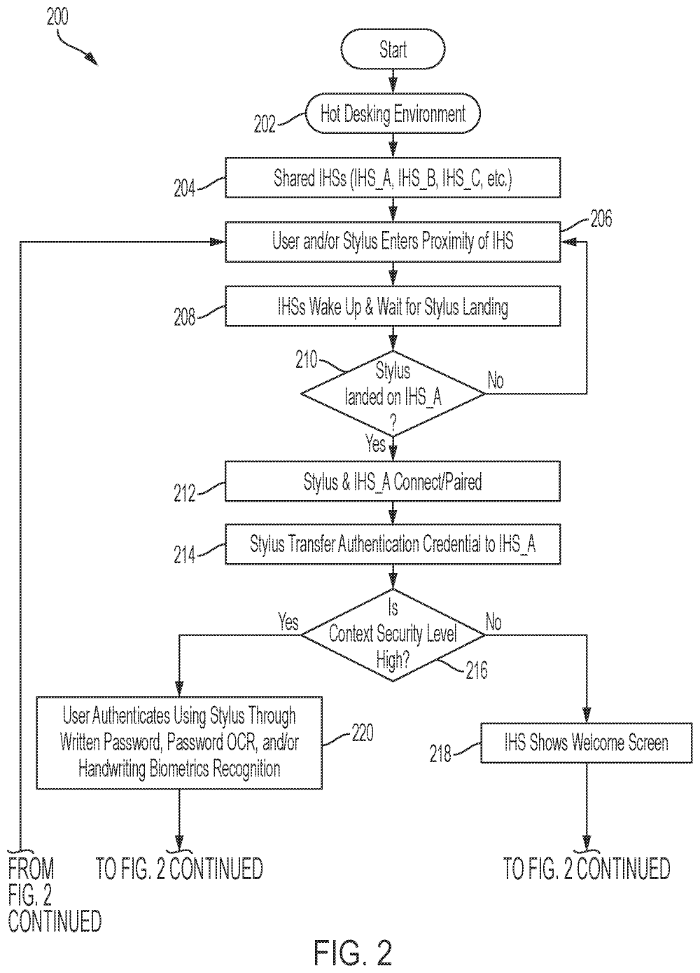

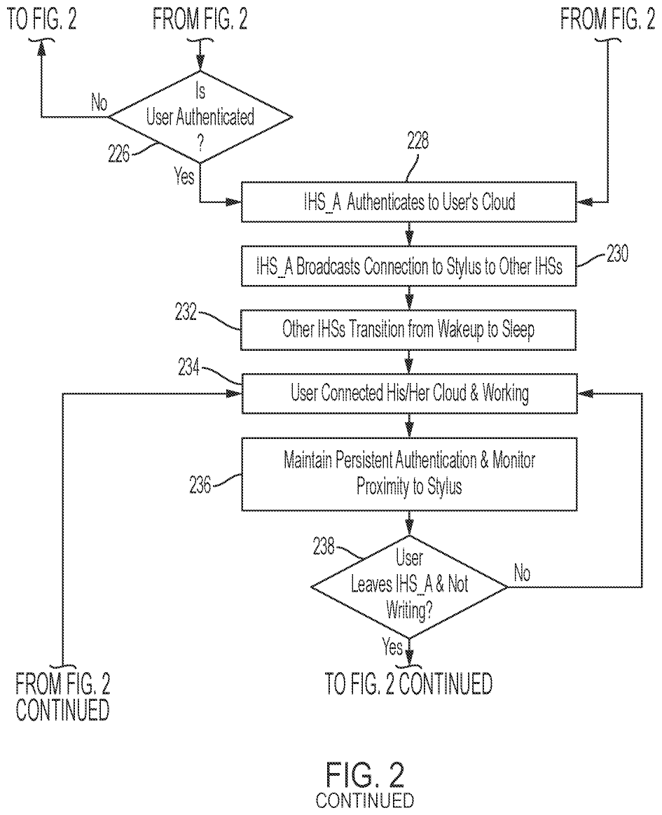

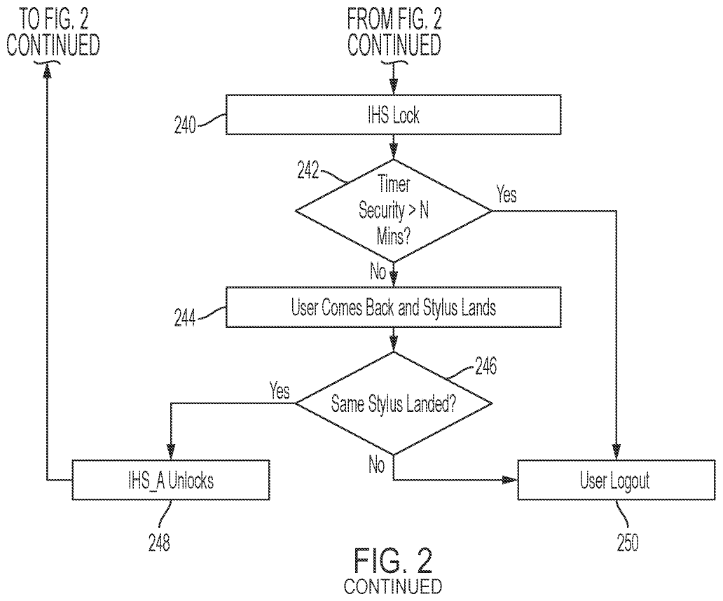

Authentication of a user to the system 110 using the stylus 120 may be performed in one example according to the method shown in FIGURE. FIG. 2 is a flow chart illustrating an example method for authenticating, locking, and logging out a user of an information handling system with a wireless stylus according to some embodiments of the disclosure. A method 200 begins in FIG. 2 at block 202 with a user entering a hot desking environment. A single desk may be shared by multiple users. For example, different users may be assigned to the desk for morning, afternoon, and evening shifts. In another example, a visitor desk may be used by users visiting from other officers. In another example, a meeting room may be occupied by different users throughout the day. At block 204, the hot desking environment has multiple shared IHSs. The shared IHSs may be available for any user in the organization to use. For example, multiple shared IHSs may include IHSs IHS_A, IHS_B, and IHS_C.

At block 206, the user may approach the shared IHSs. The stylus carried by the user enters into wireless communication proximity of the IHSs when the user approaches. In some embodiments, the wireless communication protocol used by the stylus and IHSs is BLUETOOTH or BLUETOOTH LOW ENERGY. At block 208, once the stylus has entered into proximity of the shared IHSs, the IHSs may wake up from a sleep mode and enter an awake mode. In awake mode, the IHSs' displays may activate. In awake mode, the IHSs await a stylus landing. The user performs a stylus landing by touching the tip of the stylus against the IHS screen or bringing the tip of the stylus into very close proximity with the IHS screen, such as within 2 centimeters, within 1 centimeter, within 0.5 centimeter, or within 0.25 centimeter. Touching the screen may cause a pressure sensor in the stylus to activate, which in turn may cause the stylus to wirelessly transmit a signal to the IHS.

At block 210, the IHS may determine if a stylus landing has occurred. If a landing does not occur within a specified period of time, e.g., thirty seconds, then the IHS reenters to sleep mode and returns back to block 206. If a stylus landing does occur, then the IHS proceeds to block 212. At block 212, the stylus and selected IHS, IHS_A for example, are connected. In some embodiments, the stylus and IHS_A are paired according to the BLUETOOTH or BLUETOOTH LOW ENERGY protocol or another short-range communication system. By connecting, the stylus and IHS_A may be able to exchange additional information with each other wirelessly. After connection, the stylus transfers the user's authentication credential to IHS_A at block 214. The authentication credential uniquely identifies the user. For example, the authentication credential could be a username or public key.

At block 216, the IHS may determine the context security level. The context may be determined from location, time telemetry, or other data. For example, low security may be determined when the IHS is at a home location, and high security may be determined when the IHS is at an office location or public location. If the security level is low, then the IHS proceeds to block 218. At block 218, IHS_A may display a welcome screen. When the user touches the screen with his or her stylus, IHS_A may proceed to authenticate the user based on a credential from the stylus and grant access at block 228. Block 228 may include transferring the credential to a remote computing system for verification, locally verifying the credential, and/or retrieving user information from a remote computing system.

If the security level is high in block 216, then the user is requested to write a password at block 220. OCR is performed on the password at block 222, and handwriting biometrics recognition is performed at block 224. If the password and biometrics are not matched at block 226, the IHS and stylus return to proximity connection at block 206. If the password and biometrics are matched at block 226, the method 200 continues to block 228 to authenticate the user and/or grant access.

At block 228, the user has been granted access to use IHS_A. IHS_A may transfer the user's authentication credential to the user cloud. If the user's authentication credential is authorized by the user cloud, then IHS_A may be logged into the user cloud. At step 230, IHS_A broadcasts to all of the nearby shared IHSs that IHS_A is connected to the user's stylus. The broadcast may be through a short-range communication system or a wireless local area network (WLAN) connection that directly notifies the other IHSs that are on the same network, or through a wide area network (WAN) by notifying a remote computing system that then communicates with IHSs that are grouped with the IHS_A. At step 232, the nearby shared IHSs switch back from awake mode to sleep mode because they have been notified that the user is using IHS_A. At step 234, the user is connected to the cloud and is working on IHS_A. At step 234, IHS_A may retrieve user information corresponding to the authenticated user of the stylus and configure IHS_A based on the user information. For example, a user profile including a user name, profile picture, system settings such as screen lock-out time, display brightness, menu configurations, sounds effects, or the like, may be applied to configure IHS_A. This user profile may be deleted upon logout of the user and the IHS_A returned to a default state. In some embodiments, the IHS_A may also retrieve notes taken by the user using a stylus upon the user's logging in to IHS_A to allow the user to continue notetaking where the user left off from a previous session on a previous IHS.

In some embodiments, the authentication may have criteria that cause expiration of the access to the content or the IHS. For example, at block 236, the IHS may be configured with persistent authentication and/or proximity checks to continue to allow usage of the IHS_A, which may include continuing to monitor handwriting, continuing to monitor a fingerprint sensor on the stylus, or other authentication techniques described herein. At block 238, the IHS determines whether the user has left the IHS by determining whether the stylus is out of range of the IHS and/or whether the fingerprint on the stylus no longer matches the authenticated user. If the user remains in proximity and using the stylus, the method 200 continues back to block 234 to keep the IHS unlocked and continue to perform persistent authentication checks. When the user leaves the IHS at block 238, then the IHS is locked or access to the content removed at block 240.

A timer determines at block 242 whether a predetermined amount of time, such as N minutes, is exceeded. If the user returns to proximity with the IHS and contacts the IHS with a stylus at block 244, the user may be allowed to be re-authenticated through a shorter process. For example, the IHS may determine at block 246 whether the same pen landed on the IHS. If so, the IHS may unlock at block 248 without further authentication, or with another limited authentication with fewer factors than originally used to unlock the IHS. If the user returns with a different pen at block 246, then the IHS logs the user out at block 250 and return to a default state. If the timer at block 242 is exceeded, then the IHS logs the user out at block 250. The logout at block 250 may include deleting any user content from the IHS.

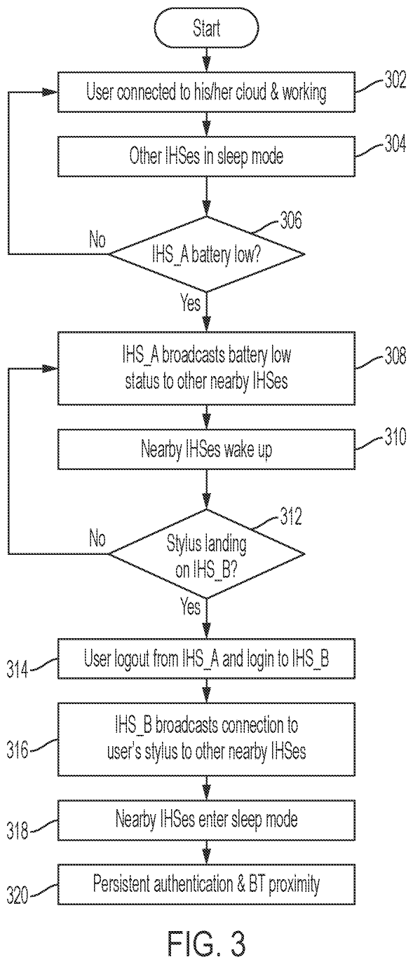

FIG. 3 illustrates a user switching IHSs due to a low battery condition, although criteria other than a low battery condition may be used to trigger a similar user switching process. For example, detection that a wireless signal has a signal level below a threshold may indicate loss of connectivity and trigger a user switching process. As another example, detection that a scheduled meeting time is ended may trigger a user switching process. A method 300 begins in FIG. 3 at block 302 with a user logged into and using an IHS, e.g., IHS_A. The user may be connected to the user cloud and is working on IHS_A. The other nearby IHSs are in sleep mode at block 304.

At block 306, IHS_A may determine if its battery is low. The battery may be determined to be low if the battery charge falls below a specified threshold, e.g., 10%. If the battery is not low, the user continues working on IHS_A at block 302. If the battery is low, then IHS_A may broadcast a low battery broadcast signal to nearby IHSs that it has a low battery. IHS_A may also display a low battery message to user. The low battery message may display the names of nearby IHSs, e.g., IHS_B, for the user to switch to. At step 310, nearby IHSs that received IHS_A's low battery broadcast signal may switch from sleep to awake mode.

At block 312, IHS_B may await the user's stylus landing on IHS_B's screen. If IHS_A does not receive a notification that the stylus landed on IHS_B within a designated period of time, then IHS_A may resume broadcasting its low battery broadcast signal at block 308. If IHS_A received notification from IHS_B that the stylus landed on IHS_B, then at block 314, IHS_A may log out the user, and IHS_B may log in the user.

At block 316, IHS_B may broadcast to nearby IHSs that it is connected to the user's stylus. The other nearby IHSs may return from awake to sleep mode in block 318. At block 320, IHS_B may be configured with persistent authentication and/or proximity checks. The persistent authentication may include periodic sampling of a fingerprint in which after the user logs in to the system, the system continues to recognize handwriting and/or recognize fingerprints for authentication as the user writes. If the user leaves the system and stylus behind and another user picks up the paper and stylus and starts writing, the stylus may detect a different fingerprint and/or different handwriting biometrics and enforce a reauthentication process for access to the system and/or content.

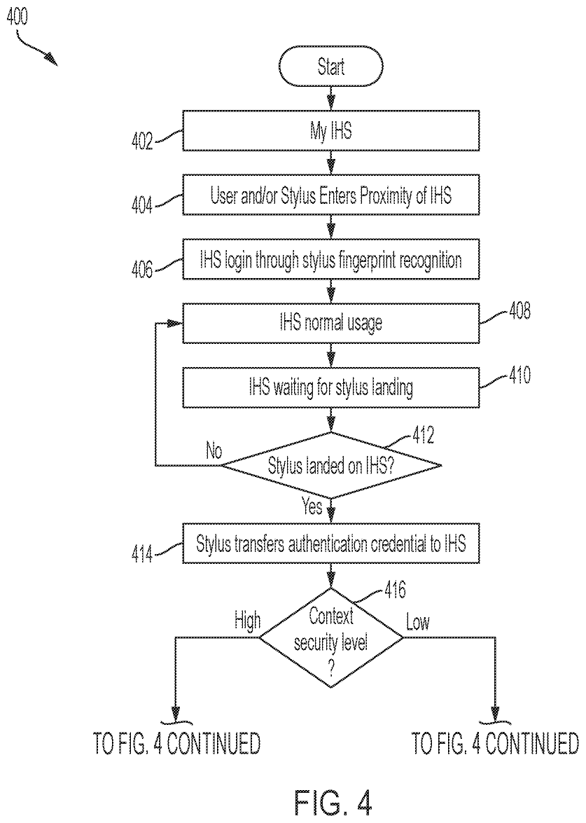

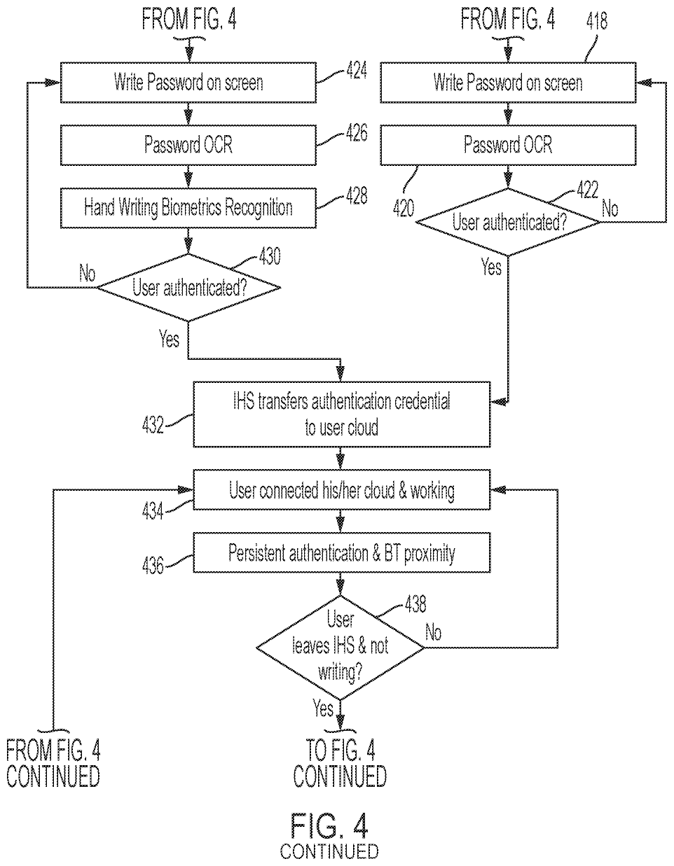

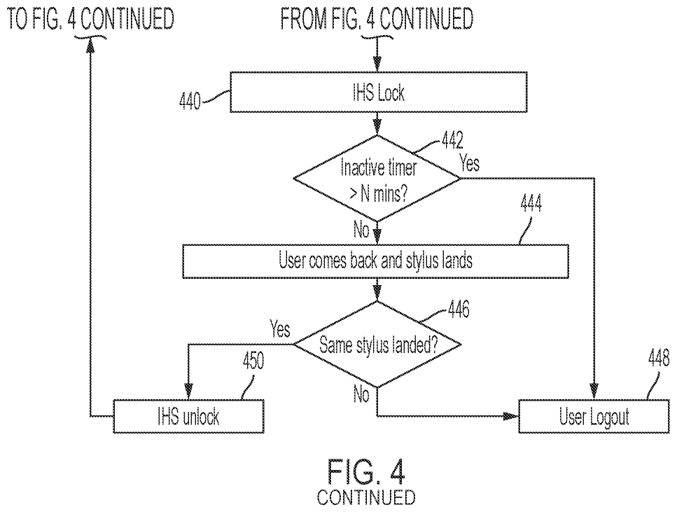

FIG. 4 is a flow chart illustrating a method for a user and a stylus authenticating to an IHS and authenticating to, locking, and logging out of a user cloud. A method 400 begins in FIG. 4 at block 402 with a user approaching an IHS. At block 404, the user and the stylus move into proximity of the IHS. The IHS may switch from sleep to awake mode. The user may log into the IHS through stylus fingerprint recognition in block 406.

After the user logs into the IHS, he or she may commence usage of the IHS at step 408. The user may not be logged into the user cloud at step 408. At step 410, the IHS may wait for a stylus landing. If a stylus landing does not occur, the user resumes using the IHS at step 408. If a stylus landing does occur, then the stylus wirelessly transfers the user's authentication credential to the IHS at step 414 to commence login to the user cloud.

At block 416, the IHS determines a context security level. If the security level is low, then the user is requested to write a password at block 418. OCR is performed on the password at block 420, and it is determined whether the password is correct at block 422. If the password is incorrect, the user is requested to re-enter the password at block 418. If the password matches at block 422, the method 400 continues to block 432 to transfer the user's authentication credential to the user cloud. If the user's authentication credential is authorized by the user cloud, then the IHS may be logged into the user cloud. If the security level is high, then the user is requested to write a password at block 424. OCR is performed on the password at block 426, and handwriting biometrics recognition is performed at block 428. If the password and biometrics are not matched at block 430, the user is again requested to write the password at block 424. If the password and biometrics are matched at block 430, the method 400 continues to block 432 to transfer the user's authentication credential to the user cloud. At step 434, the user is connected to the user cloud and is working on the IHS.

In some embodiments, the authentication may have criteria that cause expiration of the access to the content or the IHS. For example, at block 436, the IHS may be configured with persistent authentication and/or proximity checks. At block 438, the IHS determines whether the user has left the IHS by determining whether the stylus is out of range of the IHS and/or whether the fingerprint on the stylus no longer matches the authenticated user. If the user remains in proximity and using the stylus, the method 400 continues back to block 434 to keep the IHS unlocked and allow the user to keep working on the IHS. When the user leaves the IHS at block 438, then the IHS is locked or access to the content removed at block 440.

A timer determines at block 442 whether a predetermined amount of time, such as N minutes, is exceeded. If the user returns to proximity with the IHS and contacts the IHS with a stylus at block 444, the user may be allowed to be re-authenticated through a shorter process. For example, the IHS may determine at block 446 whether the same pen landed on the IHS. If so, the IHS may unlock at block 450 without further authentication, or with another limited authentication with fewer factors than originally used to unlock the IHS. If the user returns with a different pen at block 446, then the IHS logs the user out at block 448. If the timer at block 442 is exceeded, then the IHS logs the user out at block 448. The logout at block 448 may include deleting any user content from the IHS.

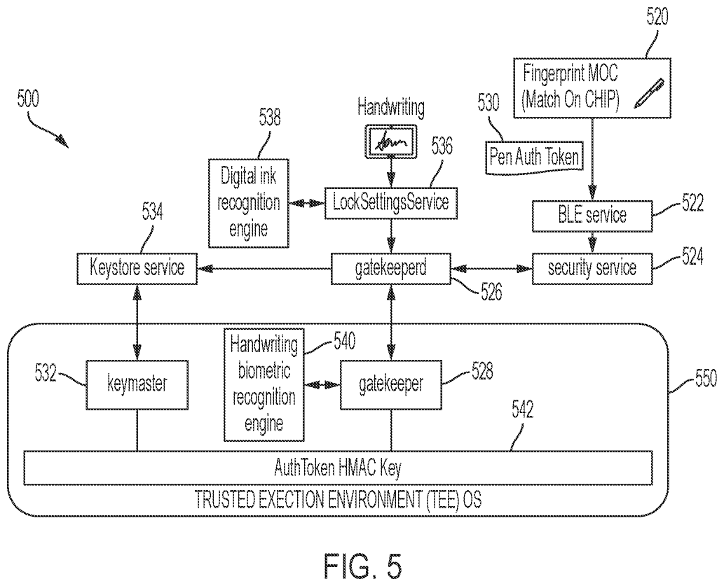

FIG. 5 is a block diagram illustrating example operations executing on an information handling system for authenticating a user, such as when performing the method of FIG. 2, FIG. 3, or FIG. 4, of the information handling system with a wireless stylus according to some embodiments of the disclosure. A system 500 may include a stylus 520, which may have match-on-chip (MOC) capability. For example, the stylus 520 may have a secure storage area for storing representations of enrolled fingerprints, which may be the fingerprints themselves or values, such as hash values, computed from fingerprints. A secure processor with access to the secure storage area may be able to generate a fingerprint token 530 when a fingerprint sensor of the stylus 520 matches an enrolled fingerprint. The token 530 may be transmitted wirelessly to an information handling system. The information handling system may have a communications service 522 to receive the token 530 and pass the token to a security service 524 for checking the authenticity of the token 530. For example, generation of the token 530 may be based, at least in part, on a certificate installed in the secure storage area of the stylus 520. The security service 524 may use a corresponding certificate to authenticate that the token 530 was generated by a secure stylus. The security service 524 then passes information to a gatekeeper daemon service 526.

The gatekeeper daemon service 526 may also receive handwriting from the user, such as through a lock settings service 536. The lock settings service 536 may process requests to access content on the system, such as a request to unlock the system from a locked state. The lock settings service 536 may receive the user handwriting input, which may be a password, and use digital ink recognition engine 538 to recognize characters in the handwriting input, and pass the user handwriting input and/or input password to the gatekeeper daemon service 526.

The gatekeeper daemon service may have a counterpart gatekeeper service 528 executing within a trusted execution environment (TEE) operating system (OS) 550. The TEE OS 550 may execute on a processor shared with other services, such as services 522, 524, 526, 534, and/or 536, but be isolated from other services to protect execution from malicious attacks. The TEE OS 550 may provide security features such as isolated execution, integrity of applications executing with the TEE, along with confidentiality of their assets. Within the TEE OS 550, the gatekeeper service 528 may receive the user handwriting input and analyze the handwriting using a handwriting biometric recognition engine 540. The engine 540 may analyze the user handwriting input, such as stroke length, applied pressure, stroke speed, and shapes and sequence of strokes used to form characters within the user handwriting input. The gatekeeper service 528 may share a hash-based message authentication code (HMAC) key 542 with a keymaster service 532. In one embodiment, an internal inter-process communication (IPC) system is used to communicate a shared secret directly between the keymaster service 532 and the gatekeeper service 528. This shared secret is used for signing tokens sent to a keystore to provide attestations of password verification. The gatekeeper service 528 may request the key from the keymaster service 532 for each use and not persist in a cache. Although several authentication techniques are illustrated in FIG. 5, the system may be configured to include or use one, two, three, or more factors for authenticating a user.

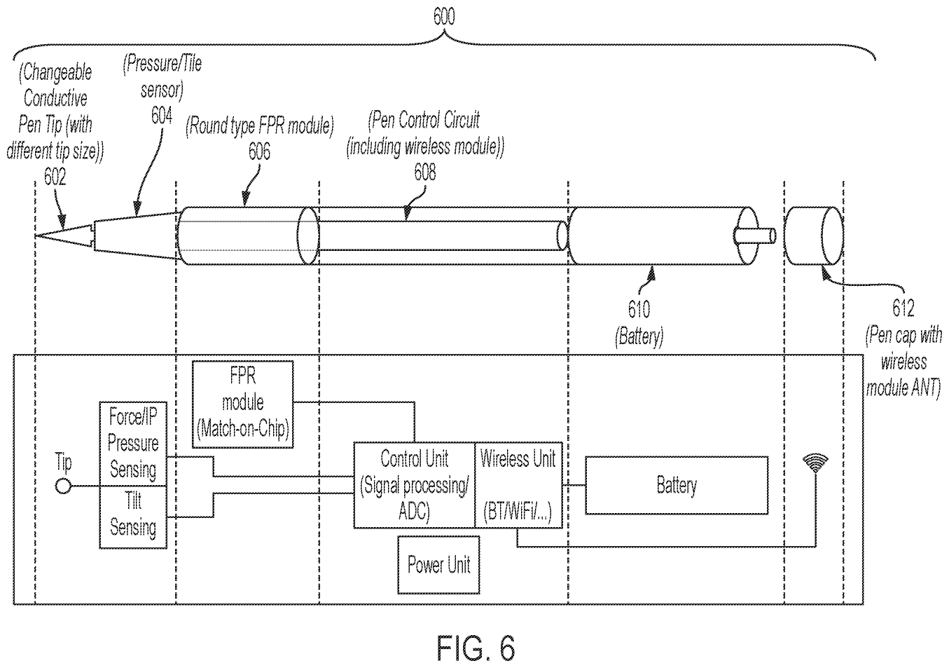

One embodiment of a stylus for authenticating a user according to some of the disclosed embodiments is shown in FIG. 6. FIG. 6 is a block diagram illustrating an example wireless stylus for authenticating a user with an information handling system according to some embodiments of the disclosure. A stylus 600 may include a changeable conductive pen tip 602, a pressure sensor 604, a fingerprint recognition (FPR) module 606, a pen control circuit 608 (including, for example, a processor, a secure storage unit, and/or a wireless communication module), a battery 610, and/or a pen cap with a wireless antenna module 612. The FPR module 606 may include a round-type FPR module that can recognize one, two, three, or more fingerprints simultaneously during holding of the stylus 600. In some embodiments, the FPR module 606 may include a match-on-chip (MOC) sensor, in which the fingerprint matching is performed on the stylus 600. The pressure sensor 604 may include a pressure sensor to detect pen writing force and/or tilt sensors to detect a pen tilt angle, and the pressure and/or tilt angle communicated to the information handling system.

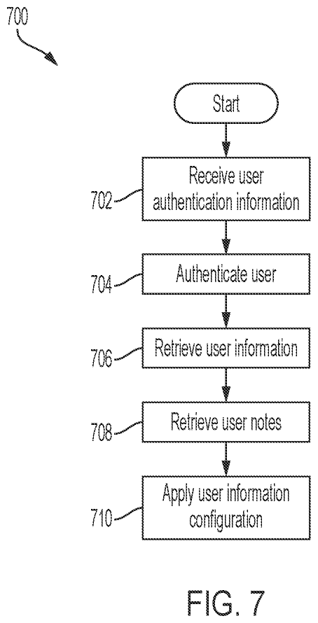

FIG. 7 is a flow chart illustrating a method for a user to authenticate to an IHS using a stylus and to configure the IHS using user information. A method 700 begins in FIG. 7 at block 702 with an IHS receiving user authentication information from a stylus. One example of receiving user authentication information from a stylus is receiving text corresponding to a user's handwritten password. Another example of receiving user authentication information from a stylus is receiving a user's handwriting biometrics corresponding to a handwritten password. Another example of receiving user authentication information from a stylus is receiving a user's fingerprint token.

At block 704, the IHS may authenticate the user of the stylus based on the user authentication information. In some embodiments, the IHS may authenticate the user itself using a locally stored authentication database or a cache of user authentication credentials. In some embodiments, the IHS may forward the user authentication information to an authentication server hosted by the organization, such as a RADIUS server. In some embodiments, the IHS may forward the user authentication information to a third-party cloud service.

At block 706, the IHS may retrieve information corresponding to the user of the stylus. In some embodiments, the user information may include a user profile. In some embodiments, the user profile may include language settings, regional settings, display resolution, color scheme, and default applications. In some embodiments, the user information is retrieved locally from a configuration file, database, or cache on the IHS. In some embodiments, the user information is retrieved from a configuration server hosted by the organization, such as an LDAP server. In some embodiments, the user information is retrieved from a third-party cloud service.

At block 708, the IHS may retrieve notes previously stored by the user of the stylus. In some embodiments, the user notes may be stored locally on the IHS. In some embodiments, the user notes may be retrieved from a file server hosted by the organization. In some embodiments, the user notes are retrieved from a third-party cloud service.

At block 710, the IHS may configure itself by applying the user information. In some embodiments, the applied user information may be the user profile, customization settings, hardware settings, software settings, security settings, web browsing cookies, session states from previous logins, or other personal information.

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

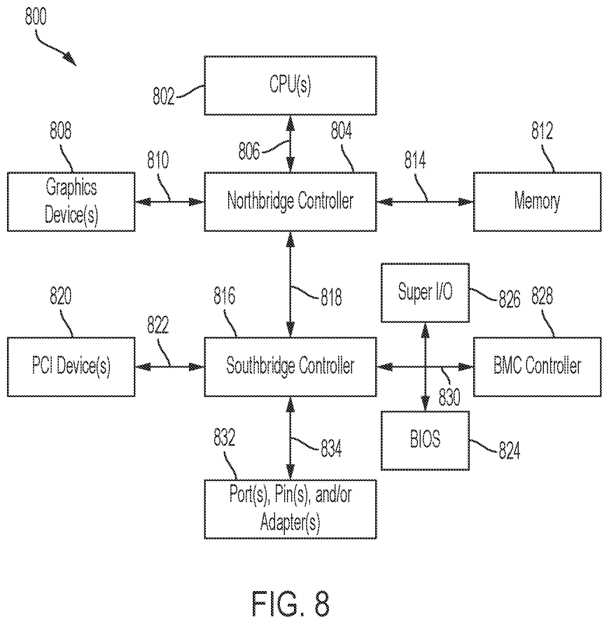

An information handling system may include a variety of components to generate, process, display, manipulate, transmit, and receive information. One example of an information handling system 800 is shown in FIG. 8. IHS 800 may include one or more central processing units (CPUs) 802. In some embodiments, IHS 800 may be a single-processor system with a single CPU 802, while in other embodiments IHS 800 may be a multi-processor system including two or more CPUs 802 (e.g., two, four, eight, or any other suitable number). CPU(s) 802 may include any processor capable of executing program instructions. For example, CPU(s) 802 may be processors capable of implementing any of a variety of instruction set architectures (ISAs), such as the x86, POWERPC®, ARM®, SPARC®, or MIPS® ISAs, or any other suitable ISA. In multi-processor systems, each of CPU(s) 802 may commonly, but not necessarily, implement the same ISA.

CPU(s) 802 may be coupled to northbridge controller or chipset 804 via front-side bus 806. The front-side bus 806 may include multiple data links arranged in a set or bus configuration. Northbridge controller 804 may be configured to coordinate I/O traffic between CPU(s) 802 and other components. For example, northbridge controller 804 may be coupled to graphics device(s) 808 (e.g., one or more video cards or adaptors, etc.) via graphics bus 810 (e.g., an Accelerated Graphics Port or AGP bus, a Peripheral Component Interconnect or PCI bus, etc.). Northbridge controller 804 may also be coupled to system memory 812 via memory bus 814. Memory 812 may be configured to store program instructions and/or data accessible by CPU(s) 802. In various embodiments, memory 812 may be implemented using any suitable memory technology, such as static RAM (SRAM), synchronous dynamic RAM (SDRAM), nonvolatile/Flash-type memory, or any other type of memory.

Northbridge controller 804 may be coupled to southbridge controller or chipset 816 via internal bus 818. Generally, southbridge controller 816 may be configured to handle various of IHS 800's I/O operations, and it may provide interfaces such as, for instance, Universal Serial Bus (USB), audio, serial, parallel, Ethernet, etc., via port(s), pin(s), and/or adapter(s) 832 over bus 834. For example, southbridge controller 816 may be configured to allow data to be exchanged between IHS 800 and other devices, such as other IHS s attached to a network. In various embodiments, southbridge controller 816 may support communication via wired or wireless data networks, such as any via suitable type of Ethernet network, via telecommunications/telephony networks such as analog voice networks or digital fiber communications networks, via storage area networks such as Fiber Channel SANs, or via any other suitable type of network and/or protocol.

Southbridge controller 816 may also enable connection to one or more keyboards, keypads, touch screens, scanning devices, voice or optical recognition devices, or any other devices suitable for entering or retrieving data. Multiple I/O devices may be present in IHS 800. In some embodiments, I/O devices may be separate from IHS 800 and may interact with IHS 800 through a wired or wireless connection. As shown, southbridge controller 816 may be further coupled to one or more PCI devices 820 (e.g., modems, network cards, sound cards, video cards, etc.) via PCI bus 822. Southbridge controller 816 may also be coupled to Basic I/O System (BIOS) 824, Super I/O Controller 826, and Baseboard Management Controller (BMC) 828 via Low Pin Count (LPC) bus 830.

IHS 800 may be configured to access different types of computer-accessible media separate from memory 812. Generally speaking, a computer-accessible medium may include any tangible, non-transitory storage media or memory media such as electronic, magnetic, or optical media, including a magnetic disk, a hard drive, a CD/DVD-ROM, and/or a Flash memory. Such mediums may be coupled to IHS 800 through various interfaces, such as universal serial bus (USB) interfaces, via northbridge controller 804 and/or southbridge controller 816. Some such mediums may be coupled to the IHS through a Super I/O Controller 826 combines interfaces for a variety of lower bandwidth or low data rate devices. Those devices may include, for example, floppy disks, parallel ports, keyboard and mouse and other user input devices, temperature sensors, and/or fan speed monitoring.

BIOS 824 may include non-volatile memory having program instructions stored thereon. The instructions stored on the BIOS 824 may be usable by CPU(s) 802 to initialize and test other hardware components. The BIOS 824 may further include instructions to load an Operating System (OS) for execution by CPU(s) 802 to provide a user interface for the IHS 800, with such loading occurring during a pre-boot stage. In some embodiments, firmware execution facilitated by the BIOS 824 may include execution of program code that is compatible with the Unified Extensible Firmware Interface (UEFI) specification, although other types of firmware may be used.

BMC controller 828 may include non-volatile memory having program instructions stored thereon that are usable by CPU(s) 802 to enable remote management of IHS 800. For example, BMC controller 828 may enable a user to discover, configure, and/or manage BMC controller 828. Further, the BMC controller 828 may allow a user to setup configuration options, resolve and administer hardware or software problems, etc. Additionally or alternatively, BMC controller 828 may include one or more firmware volumes, each volume having one or more firmware files used by the BIOS firmware interface to initialize and test components of IHS 800.

One or more of the devices or components shown in FIG. 8 may be absent, or one or more other components may be added. Further, in some embodiments, components may be combined onto a shared circuit board and/or implemented as a single integrated circuit (IC) with a shared semiconductor substrate. For example, northbridge controller 804 may be combined with southbridge controller 816, and/or be at least partially incorporated into CPU(s) 802. Accordingly, systems and methods described herein may be implemented or executed with other computer system configurations. In some cases, various elements shown in FIG. 8 may be mounted on a motherboard and enclosed within a chassis of the IHS 800.

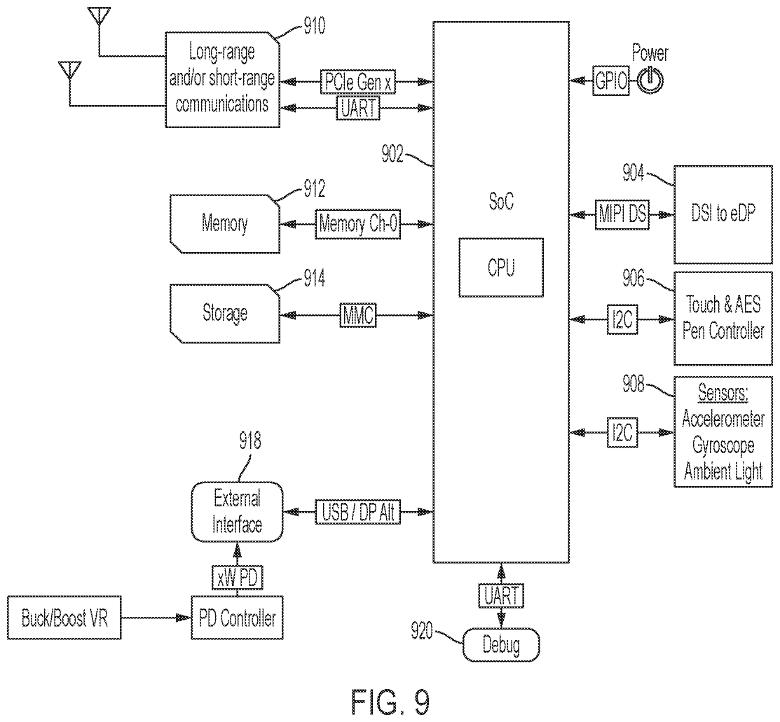

One example embodiment of the generic information handling system illustrated in FIG. 8 is shown in FIG. 9. FIG. 9 may be a mobile device, such as a mobile phone or tablet computing device, with computing tasks controlled, at least in part, by a system on chip (SoC). For example, SoC 902 may include an application processor (AP) comprising a central processing unit (CPU). The SoC 902 may also include other logic functionality including an audio processor, a video processor, a digital signal processor. Logic circuitry of the SoC 902 may read and write data stored in memory 912, which may be a volatile memory accessed through a memory channel interface. In some embodiments, the memory 902 and associated circuitry may be integrated in the SoC 902. The SoC 902 may also read and write data stored in storage 914, which may be a non-volatile memory accessed through an interface, such as a MultiMediaCard (MMC), Serial ATA, USB, and/or PCI Express interface. In some embodiments, the storage 914 and associated circuitry may be integrated in the SoC 902.

The SoC 902 may communicate through wired or wireless connections with other devices. For example, a long-range and/or short-range communication module 910 may provide wireless communications for the SoC 902 through one or more of a PCI Express or universal asynchronous receiver-transmitter (UART) interface. Example long-range communications include communications techniques that extend beyond 10 feet, beyond 30 feet, beyond 50 feet, or beyond 100 feet, such as 802.11a, 802.11b, 802.11g, 802.11n. Example short-range communications include communication techniques that do not extend beyond 10 feet, beyond 30 feet, beyond 50 feet, or beyond 100 feet, such as Bluetooth. A wired external interface 918 for communication may provide data communications and/or power. For example, the external interface 918 may be a Type-C USB port with Power Delivery capability that receives power from an external buck/boost voltage regulator. In some embodiments, the external interface 918 is integrated into the SoC 902.

The SoC 902 may also include interfaces to other components. For example, the SoC 902 may provide an output to a display through a display serial interface (DSI) and/or embedded display port (eDP) 904. As another example, the SoC 902 may receive input from a touch screen interface or a stylus controller through an Inter-Integrated Circuit (I2C) interface 906. As a further example, the SoC 902 may receive input from sensors 908 through an I2C interface, including information from an accelerometer, gyroscope, and/or ambient light sensor. Any of the interfaces 904, 906, and/or 908 may likewise be integrated in the SoC 902. In some embodiments, an external debug interface 920 may be provided through a UART interface.

These example embodiments describe and illustrate various authentication techniques for authenticating access to a system or content on an information handling system, such as using a stylus. For example, referring to the information handling system of FIG. 9, the SoC 902 may receive stylus input through interface 906, perform authentication using the handwriting on the CPU, and generate response prompts indicating successful or unsuccessful authentication through the display interface 904.

The schematic flow chart diagrams of FIG. 2, FIG. 3, FIG. 4, and FIG. 7 are generally set forth as a logical flow chart diagram. As such, the depicted order and labeled steps are indicative of aspects of the disclosed method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The operations described above as performed by a processor may be performed by any circuit configured to perform the described operations. Such a circuit may be an integrated circuit (IC) constructed on a semiconductor substrate and include logic circuitry, such as transistors configured as logic gates, and memory circuitry, such as transistors and capacitors configured as dynamic random access memory (DRAM), electronically programmable read-only memory (EPROM), or other memory devices. The logic circuitry may be configured through hard-wired connections or through programming by instructions contained in firmware. Further, the logic circuitry may be configured as a general-purpose processor capable of executing instructions contained in software and/or firmware.

If implemented in firmware and/or software, functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise random access memory (RAM), read-only memory (ROM), electrically-erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and Blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and certain representative advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. For example, although processing of certain kinds of data may be described in example embodiments, other kinds or types of data may be processed through the methods and devices described above. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method, comprising:
receiving, by a first information handling system, user authentication information from a user of a stylus through the stylus;
authenticating, by the first information handling system, the user of the stylus based on the user authentication information;
retrieving, by the first information handling system, user information corresponding to the user of the stylus; and
configuring the first information handling system by applying the user information.

2. The method of claim 1, wherein receiving the user authentication information comprises at least two of:
receiving text corresponding to a handwritten password;
receiving handwriting biometrics corresponding to a handwritten password; or
receiving a fingerprint token.

3. The method of claim 1, further comprising retrieving notes previously stored by the user of the stylus.

4. The method of claim 1, wherein retrieving the user information comprises retrieving a user profile corresponding to the user of the stylus, wherein configuring the first information handling system comprises applying the user profile to the first information handling system.

5. The method of claim 1, further comprising:
determining, by the first information handling system, a predetermined period of time has passed without receiving input from the stylus;
configuring the first information handling system to a default state after determining the predetermined period of time has passed;
receiving, by a first information handling system, second user authentication information from a second user of a second stylus through the second stylus while in the default state;
authenticating, by the first information handling system, the second user of the second stylus based on the second user authentication information;
retrieving, by the first information handling system, second user information corresponding to the second user of the second stylus; and
configuring the first information handling system by applying the second user information.

6. The method of claim 1, further comprising:
determining, by the first information handling system, a battery charge level of the first information handling system is below a threshold level;
transmitting, by the first information handling system, a low battery broadcast signal to a second information handling system;
receiving, by the first information handling system, a notification from the second information handling system that the user was authenticated on the second information handling system; and
configuring the first information handling system to a default state after receiving the notification from the second information handling system.

7. A method, comprising:
receiving, at a first information handling system, a low battery broadcast signal from a second information handling system while the first information handling system is in a sleep mode;
transitioning, by the first information handling system, from the sleep mode into an awake mode in response to receiving the low battery broadcast signal;
determining, by the first information handling system, whether a fingerprint token is received from a stylus that was previously authenticated to the second information handling system with a predetermined period of time of receiving the low battery broadcast signal;
when the fingerprint token is received within the predetermined period of time, logging in a user associated with the fingerprint token to the first information handling system; and
when the fingerprint token is not received within the predetermined period of time, transitioning, by the first information handling system, from the awake mode to the sleep mode.

8. The method of claim 7, further comprising:
broadcasting, by the first information handling system, a successful user login to other information handling systems.

9. The method of claim 7, further comprising:
authenticating the user to cloud storage, wherein the step of authenticating a user to cloud storage comprises:
receiving a handwritten password on a screen of the information handling system;
converting the handwritten password into password text; and
transmitting the password text to the cloud storage.

10. The method of claim 9, wherein the step of authenticating the user to the cloud storage further comprises:
determining handwriting biometrics based on the received handwritten password; and
transmitting the handwriting biometrics to the cloud storage.

11. The method of claim 9, further comprising:
loading data associated with the user from the cloud storage.

12. The method of claim 9, further comprising:
logging out the user from the information handling system; and
erasing data associated with the user from the information handling system.

13. The method of claim 7, further comprising:
logging out the user from the information handling system after a predefined period of inactivity.

14. An apparatus, comprising:
a first information handling system, comprising
a memory;
a processor coupled to the memory, wherein the processor is configured to perform steps comprising:
receiving user authentication information from a user of a stylus through the stylus;
authenticating the user of the stylus based on the user authentication information;
retrieving user information corresponding to the user of the stylus; and
configuring the first information handling system by applying the user information.

15. The apparatus of claim 14, wherein the step of receiving the user authentication information comprises at least two of:
receiving text corresponding to a handwritten password;
receiving handwriting biometrics corresponding to a handwritten password; or
receiving a fingerprint token.

16. The apparatus of claim 14, wherein the processor is further configured to perform the step of retrieving notes previously stored by the user of the stylus.

17. The apparatus of claim 14, wherein the step of retrieving the user information comprises retrieving a user profile corresponding to the user of the stylus, wherein the step of configuring the first information handling system comprises applying the user profile to the first information handling system.

18. The apparatus of claim 14, wherein the processor is further configured to perform the step of:
determining a predetermined period of time has passed without receiving input from the stylus;
configuring the first information handling system to a default state after determining the predetermined period of time has passed;
receiving second user authentication information from a second user of a second stylus through the second stylus while in the default state;
authenticating the second user of the second stylus based on the second user authentication information;
retrieving second user information corresponding to the second user of the second stylus; and
configuring the first information handling system by applying the second user information.

19. The apparatus of claim 14, wherein the processor is further configured to perform the steps of:
determining a battery charge level of the first information handling system is below a threshold level;
transmitting a low battery broadcast signal to a second information handling system;
receiving a notification from the second information handling system that the user was authenticated on the second information handling system; and
configuring the first information handling system to a default state after receiving the notification from the second information handling system.

20. The apparatus of claim 14, wherein:
the apparatus is a tablet comprising a system-on-chip,
wherein the system-on-chip comprises the processor,
wherein the processor is configured to perform steps comprising executing a trusted execution environment (TEE),
wherein at least part of the authenticating the user of the stylus based on the user authentication information is performed within the trusted execution environment (TEE), and
wherein the apparatus further comprises a short-range communication module configured to communicate with the stylus.
